(19) United States
(12) Patent Application Publication
(10) Pub. No.: US 2025/0374940 A1
(43) Pub. Date: Dec. 11, 2025

(54) PROCESS AND APPARATUS FOR OBTAINING FOOD PRODUCTS FROM DURUM WHEAT, AND THUS OBTAINED PRODUCTS

(71) Applicant: CASILLO NEXT GEN FOOD S.R.L., Corato (BA) (IT)

(72) Inventors: Marcello Greco Miani, Corato (BA) (IT); Francesco Casillo, Corato (BA) (IT)

(73) Assignee: CASILLO NEXT GEN FOOD S.R.L., Corato (BA) (IT)

(21) Appl. No.: 18/872,902

(22) PCT Filed: Jun. 14, 2023
(86) PCT No.: PCT/IB2023/056130

§ 371 Date: Dec. 9, 2024

(30) Foreign Application Priority Data
Jun. 14, 2022 (IT) 102022000012611
Jan. 10, 2023 (IT) 102023000000180

(51) Int. Cl. A23L 7/10; A21D 8/04; A23D 9/04; A23L 7/152; B02B 1/04; B02B 5/02; B02C 9/00

(52) U.S. Cl. CPC A23L 7/115; A21D 8/045; A23D 9/04; A23L 7/152; B02B 1/04; B02B 5/02; B02C 9/00

(57) ABSTRACT

The present invention relates to a process for obtaining durum wheat oil starting from durum wheat. further obtaining a defatted meal and durum wheat lecithin. The invention further relates to a process for obtaining flour products of defatted durum wheat germ and defatted durum wheat bran starting from said defatted meal of durum wheat. The present invention relates to a process starting from the defatted meal of durum wheat for obtaining a natural sourdough and a dried natural sourdough therefrom. A further object of the invention are the thus obtained products: durum wheat oil, defatted meal and durum wheat lecithin, flour products of defatted durum wheat germ and defatted durum wheat bran, a natural sourdough, and a dried natural sourdough.

### FIELD OF THE INVENTION

The present invention relates to a process for the production of food products such as wheat oil, wheat lecithins, natural sourdough, defatted wheat germ and defatted wheat bran starting from selected milling fractions of durum wheat bran and durum wheat germ.

Object of the present invention are also the thus obtained food ingredients, characterized by peculiar nutritional values and organoleptic characteristics.

Not least, it is an object of the present invention the apparatus for implementing the production process according to the present invention.

The production process according to the present invention allows to obtain food ingredients having peculiar nutritional values and organoleptic characteristics.

### BACKGROUND ART

As it is known, the wheat, or grain, is one of the most important cereals for the human nutrition, and the most cultivated and consumed in many countries of the world, including Italy.

Even though substantially three groups of the wheat of the genus Triticum exist depending on the chromosome number, other aspects characterizing the cereal such as the adhesion or not of glumes and glumelles to mature caryopsis, or the presence of the beard, allow other possible classifications such as naked or dressed wheats and, respectively, aristate, semi-aristate and dumb wheats.

The most cultivated species are durum wheat and common wheat. From the bromatological point of view of the two types of wheat, i.e., from the composition, characteristics and chemical properties and chemical-physical and physical properties point of view, they are very similar, however the durum wheat, besides the different number of chromosomes, has a slightly higher protein content.

Instead, the differences in the products obtained from their milling (flours and by-products) are notable: the durum wheat gives rise to groats and semolinas with large granules, with sharp edges and a slightly amber colour, to be used mostly for pasta production; instead, from soft wheat flours are obtained, with small, round, white colored granules, from whose processing bread and bakery products are obtained.

As it is known, the bran is mainly consisting of fiber, mineral salts, and antioxidant compounds, and it is obtained from the pericarp, i.e., from the outermost part of the wheat caryopsis.

Considered for many years as a waste product suitable only for feeding livestock, in recent decades its important role in human nutrition has been recognized. The most known bran is obtained from the wheat milling and it is commercially available. It is obtained from durum wheat, soft wheat, or in the form of a mixture of both types.

The endosperm, which is the most important kernel part for food purpose, is located in the innermost part of the caryopsis. It comprises the aleuronic layer, consisting of mono-layered cells rich in high biological value proteins, lipids, vitamins, mineral salts, and enzymes. In the center, the amylaceous endosperm is located, with cells containing starch granules (60-70%) and reservoir proteins (8-18%). The form and size of the starch granules are typical for each cereal, so that it is possible, by microscopic examination, to recognize the flour provenience.

Finally, separated from the endosperm from an external coating called scutellum, the embryo or germ is present inside the caryopsis, representing the part from which a new plant is formed when the conditions for germination occur. It has a high protein and lipid content. The germ fraction is rich in lipids and oxidative and hydrolytic enzymes such as lipases, lipoxygenases, and proteases; for this reason, it is known to remove the germ from flour products since it causes oxidative and hydrolytic processes reducing inevitably the flour products durability.

To date, the milling sector of the durum wheat produces semolina and re-milled semolina with yields of 75-80% from the wheat grain (caryopsis) and 20-25% of by-products consisting mainly of brans and germ.

Therefore, bran and germ have specific nutritional and functional characteristics (nutraceutical bioactive substances) and for this reason they can be valued using food technologies suitable for the recovery of these substances, the possible purification thereof, and the use as ingredients in food products, pharmaceutical products, food supplements, cosmetics.

Nowadays the research is increasingly leaning towards strengthening the knowledge of the food characteristics and using lifestyles which better and more effectively affect brain capacity and psychophysical well-being in general, succeeding at the same time to impact on the neurodegeneration molecular mechanisms involved in the aging pathogenetic determinism, including neurodegenerative diseases. The nutraceutical science is the new frontier, i.e., the study of food products having a positive impact on a healthy life until the healthy aging. The nutraceutical food is also referred to as functional food.

Therefore, the nutraceutical science is consisting in the study of food, or components thereof, having a beneficial function on human health in terms both of prevention and direct therapeutic effect.

In nutraceutical formulations, wheat germ and bran provide an important contribute, nevertheless some cereal intrinsic characteristics make them difficult to use, and cause the presence of high waste amounts in the production processes treating wheat.

As it is known, lipids in caryopsis are generally scarcely considered due to their limited amount (the maximum concentration is in the germ). Nonetheless, their importance is relevant from both a nutritional and technological point of view. The cereal lipids constitute an extremely heterogeneous class of substances, distributed in a very diversified way in the different grain tissues.

The caryopsis, besides triglycerides, the most represented in the endosperm tissue, contains lipids as well, whose functional (emulsifying, stabilizing) properties allow interactions with protein and starch molecules and are strategic for technologic transformations.

Qualitative differences were found in the composition of caryopsis lipids of durum wheat compared to soft wheat (Narducci et al., 2019 Research Centre for Food and Nutrition, Council for Agricultural Research and Economics (CREA), as well as in some oil-specific main nutrients such as Tocochromanols (Vitamin E), Carotenoids (beta carotene) and Sterols.

The relevant presence of unsaturated and polyunsaturated fatty acids in cereal lipids unfortunately makes the alteration phenomena, such as rancidity, very frequent.

Such high alteration makes necessary cereal refining treatments (separation of the only endosperm) ensuring an easier conservation; however, a drawback consists in the fact that such treatments lower the nutritional value.

The processes and methods of oil extraction from wheat (germ and bran) were studied in the literature and the results are congruent in showing that the control of the free fatty acids (acidity-FFA) of these raw materials is very important to preserve the quality of the extracted oil (Vladimiro Cardenia et al. Eur. J. Lipid Sci. Technol. 2018).

In the literature, the processes for the milling of durum wheat and oil extraction and refining from the obtained by-products lead to products containing a high amount of free fatty acids (acidity-FFA) (Squeo G. et al., Foods, vol. 11, n. 5, 2022).

In the literature, the best qualitative-quantitative characteristics have been obtained with solvent (n-hexane) extraction methods.

In the literature, there are also many studies related to the stabilization of the germ and bran fractions to contain the acidity increase evidently showing that, to better preserve the quality of the extracted oils, a correct wetting of the wheat is required (Marzocchi et al. Foods 2022) and, most of all, respecting short time ranges between milling and oil extraction is required so that the latter occurs in the shortest possible time after the decortication/sieving (Vladimiro Cardenia et al. Eur. J. Lipid Sci. Technol. 2018).

The oil extraction allows to stabilize also the starting materials (germ and bran) extracted therefrom; the meals (germ and defatted bran), at this point defatted and being subjected to thermal treatments before and after the extraction process, are stable also against possible biological alterations due to reduced moisture content (6-8%) and activity water (a_{w}<0.3).

To date, production processes for oil extraction of durum wheat are not known, and accordingly no food products (ingredients) are known obtainable from the subsequent processing steps of defatted durum wheat germ and bran, having a reduced percentage of free fatty acids, and therefore characterized by a high quality of the final product.

There are scientific publications on characteristics and use of defatted wheat germ but all refer to soft wheat germ, not to durum wheat germ.

### SUMMARY OF THE INVENTION

In light of the above, the object of the present invention is providing a process for the production of food ingredients such as wheat oil, wheat lecithins, natural sourdough, defatted wheat germ, defatted wheat bran and wheat fiber starting from selected milling fractions of durum wheat bran and durum wheat germ.

Object of the present invention are also the thus obtained food ingredients, characterized by peculiar nutritional values and organoleptic characteristics.

Not least, it is an object of the present invention the apparatus for implementing the production process according to the present invention.

The production process according to the present invention allows to obtain food ingredients having peculiar nutritional values and organoleptic characteristics.

### LIST OF THE FIGURES

Further characteristics and advantages of the process according to the present invention will become clearer from the following exemplifying but non-limiting description of preferred embodiments of the present invention which will be given hereinafter with the aid of the attached drawings wherein:

FIG. 1 shows a block diagram of the process for obtaining food products starting from durum wheat according to the present invention;

FIG. 2 shows a block diagram of the sequence of process steps for obtaining durum wheat oil, a defatted meal of durum wheat germ and bran and durum wheat lecithins according to a first aspect of the present invention;

FIG. 3 shows a block diagram of the sequence of process steps for obtaining flour products of defatted durum wheat germ and defatted durum wheat bran according to a first aspect of the present invention;

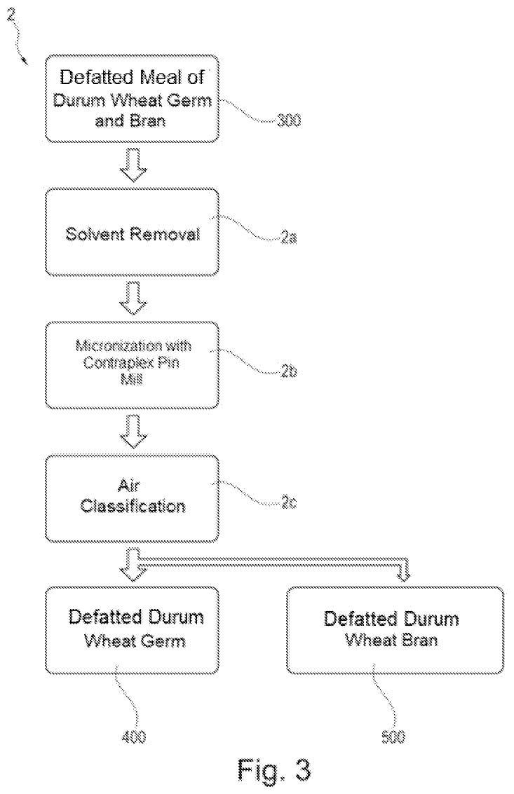

FIG. 4 shows a block diagram of the sequence of process steps for obtaining natural sourdough by biological fermentation of a defatted meal of durum wheat germ and bran obtained by the process object of the present invention.

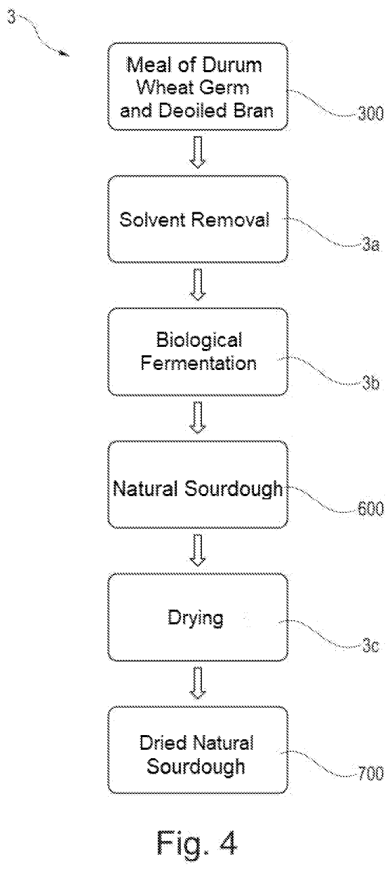

### DETAILED DESCRIPTION OF THE INVENTION

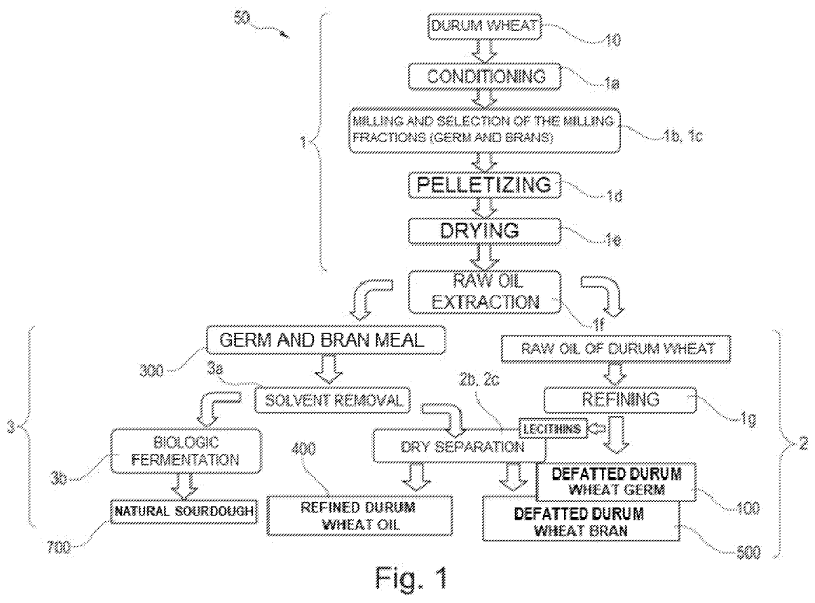

With particular reference to the block diagram of FIG. 1, schematically representing the steps of the process 50 for obtaining food products starting from durum wheat 10 (Triticum durum), preferably bran or germ, according to the present invention.

According to a preferred aspect, the starting durum wheat 10 is consisting of a mixture selected from 90-60% w/w decorticated durum wheat and 10-40% w/w durum wheat middling, preferably 80% and 20% w/w or 70% and 30% w/w, and more preferably 60% and 40% w/w durum wheat middling.

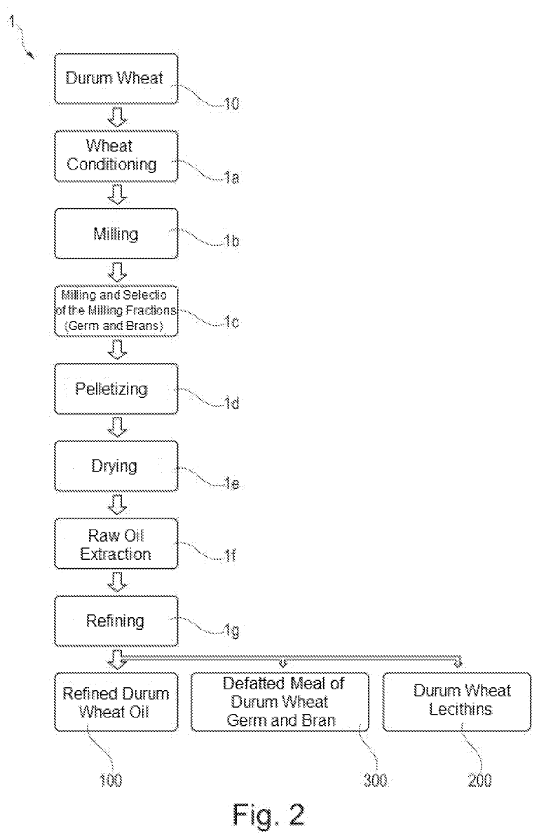

The process depicted in FIG. 1 allows to extract refined durum wheat oil 100 from the starting durum wheat 10, obtaining at the same time a defatted meal 300 and durum wheat lecithin 200, according to what shown in the diagram of FIG. 2 illustrating the process 1 according to the present invention which, starting from durum wheat 10 as raw material, allows to obtain in particular a defatted meal 300 of durum wheat germ and bran.

Said defatted meal 300 of durum wheat germ and bran can advantageously constitute the starting raw material of the further process 2 for obtaining flour products of defatted durum wheat germ 400 and defatted durum wheat bran 500 illustrated in FIG. 2, as well as said defatted meal 300 of durum wheat germ and bran can constitute the starting raw material of the further process 3 for obtaining natural sourdough 600 by biological fermentation of said meal 300 obtained by the process 1 object of the present invention.

Said defatted durum wheat bran 500 can advantageously constitute the starting raw material for obtaining the wheat fiber 800 by micronization 4a and turbo-separation 4b.

Advantageously, the selection of the starting durum wheat 10, i.e., of the durum wheat brans and germ, intended to the wheat oil extraction by the process 1 object of the present invention, is carried out with the analytical research of marker molecules present in the germ since constituent of the caryopsis with higher nutritional and functional (nutraceutical) value.

Specifically, the searched analytical markers are:
WGA (Wheat Germ Glutenin), i.e., the wheat germ agglutinin;
Vitamin E, specifically the α-tocopherol isomer with three methyl groups.

The wheat germ agglutinin (WGA) is a lectin protecting the wheat (Triticum) from insects, bacteria, and yeasts. It is mostly found in the seeds and it is abundant in the wheat germ from 100 to 500 ppm, for this reason it can be used as analysis to discriminate the milling products containing germ or germ fractions.

The α-tocopherol with three methyl groups, is the Vitamin E isomer and it is biologically more active than the other homologues, it is endowed with a in vivo higher antioxidant activity, and it is mainly present in the wheat germ fraction.

Therefore, the specific analytical markers confirming the presence of the wheat germ in the selected milling fractions preferably have the following values:

WGA: >100 ppm;

Vitamin E (α-tocopherol): >8 ppm, preferably >10 ppm, more preferably >30 ppm. According to a preferred aspect the Vitamin E (α-tocopherol) ranges from 30 to 60 ppm, more preferably from 30 to 50 ppm, even more preferably from 30 to 40 ppm. The WGA quantitative determination is carried out by the ELISA anti-WGA immunoenzymatic assay.

The quantitative determination of Vitamin E (α-tocopherol) occurs by high-resolution liquid chromatography (HPLC) according to the ISO 9936:2016 analytical method.

According to a first aspect of the present invention, the process 1 for obtaining durum wheat oil, also referred to as oil of wheat germ, and of durum wheat bran and of a defatted meal comprises a conditioning step, or wetting, 1a of the durum wheat wherein the wheat is wet, advantageously with water, to an extent preferably equal to about 3-5% w/w with respect to the durum wheat, and let rest in silos referred to as “rest cells”.

According to the present invention, with the expression durum wheat oil it is intended also wheat germ oil.

Preferably, said conditioning step 1a of the wheat provides for the wetting of the wheat with water at a pH comprised between 7 and 9.5, preferably comprised between 7 and 9, and the next rest step is carried out for 6-8 hours.

The wetting is a fundamental process allowing the water permeation within the caryopsis allowing an easier and more efficient mechanical removal of the external layers (brans and germ) during the next mechanical milling steps (breaking, uncoating, etc.).

According to the present invention, the water is filtered or osmotized and it is characterized by an electrical conductivity value comprised between 5 and 25 μS/cm. The water can be obtained by micro-filtration/ultra-filtration or reverse osmosis, preferably starting from drinking water.

The conductivity was measured at 25° C. according to the APAT CNR IRSA 2030 Man 29 2003 analytical method.

The presence of some pro-oxidant metals (for example, iron and copper) and other pollutants in the water has to be controlled or avoided since it favors fat alteration phenomena (oxidative rancidity); the use of water according to the invention, as well as the pH control of the water itself (at values comprised between 7 and 9) are fundamental to preserve the quality of the extracted oil as well as of the defatted bran and germ deriving from the extraction process 1.

The water characteristics during the wetting process of the wheat are a fundamental parameter for containing the lipase activity and the consequent increase of free acidity (FFA) which is notoriously very high in the brans and mostly in the germ (Vladimiro Cardenia et al. Eur. J. Lipid Sci. Technol. 2018).

Following the conditioning, the wheat is subjected to the milling step 1b.

During the first milling step 1b, pre-cleaning, cleaning, and optical selection operations are carried out to remove the impurities from the different wheat types which can differ for caryopsis classification for size, color, density.

The optical selection is carried out using a cereal optical selector, such as SORTEX from Bülher group.

In the following milling step 1c, referred to as decortication, instead, the largest part of the bran and germ is removed; preferably the decortication is equal to or higher than 12% w/w of the caryopsis, removing completely the germ from the kernel. Therefore, if the decortication is less than 12% w/w, part of the germ will be subsequently discarded in the following milling operations of sieving carried out by plansichters or purifiers.

Specifically, the process according to the present invention can advantageously provide for the milling of on average 4 to 6 different wheat types of different origin.

Back to the steps of process 1, after the milling steps 1b and 1c, the pelletizing step 1d occurs, i.e., a step wherein the milling fractions of durum wheat germ and brans are compressed in a machine known as “pelletizer”. Such pressing step advantageously occurs by adding a water/vapor mixture at a temperature of preferably about 80° C.

The pellet realization process can also be very fast, for example lasting about 10 minutes from the moment wherein the milling fractions are produced from the mills until the pellet final realization.

The thus obtained pellet is then dried during a drying step 1e wherein the pellet reduces its moisture at least of 5% by weight with respect to the total weight of the initial pellet. Advantageously, the pellet in the pelletizing step 1d has an average moisture of 13% w/w obtaining a final average moisture of about 8% w/w.

The drying step 1e can preferably occur on continuous belts, preferably at a temperature of 90° C. in HTST (high temperature short time). This is to better preserve the nutritional/functional value of the pellet itself.

Following the drying step le the process according to the present invention provides for the extraction step 1f of the raw oil.

The extraction step 1f of the raw oil advantageously occurs by a continuous process in counter-current flow of enriched mixtures of solvent n-hexane/wheat oil.

Preferably the process occurs at a temperature of about 65° C. for a time period of 4-5 hours until obtaining an oil maximum residue in the meal equal to 0.5% w/w of the total lipids.

Following the extraction step 1f of the raw oil a final step of refining 1g (1g-1) of the raw oil is provided, which allows to make edible the thus extracted durum wheat oil 100, according to known methods.

The refining step 1g allows to make edible the oil 100, with hexane values within the limits of the law.

The durum wheat oil 100 obtainable by the above-described process 1, which is a further object of the present invention, has, for example, excellent nutritional values as shown herein below (Table 1), besides to a fatty acid composition (Table 2) and a chemical physical analysis (Table 3) as shown herein below.

TABLE 1
Nutritional information for 100 g of product:

| Parameter | Value | Unit |
|---|---|---|
| Energy value | 900/3700 | kcal/kJ |

Fats

| | | |
|---|---|---|
| Saturated | 16.0 | G |
| Mono-unsaturated | 20.0 | G |
| Poly-unsaturated | 64.0 | G |
| Carbohydrates | 0 | G |
| Proteins | 0 | G |
| Fiber | 0 | G |

TABLE 2
Fatty acids composition % (GLC ISO 5508):

| Fatty acids | Value | Unit |
|---|---|---|
| Myristic acid | ND | % |
| Palmitic acid | 12.0-19.0 | % |
| Palmitoleic acid | ND-0.3 | % |
| Heptadecanoic acid | ND-0.1 | % |
| Stearic acid | 1.0-2.0 | % |
| Oleic acid | 12.0-25.0 | % |
| Linoleic acid | 52.0-59.0 | % |
| Linolenic acid | 3.0-10.0 | % |
| Arachic acid | ND-1.0 | % |
| Eicosenoic acid | ND-1.0 | % |
| Behenic acid | ND | % |
| Lignoceric acid | ND | % |

TABLE 3
Chemical and chemical-physical analyses:

| Parameter | Value | | Unit |
|---|---|---|---|
| Peroxide value* | Max | 7.0 | meqO2/kg |
| Density | 0.918-0.925 | | g/cm3 |
| Unsaponifiable fraction | 2-4 | | % |
| Total Sterols (phytosterol) | Min | 1.5 | % |
| Total Policosanols | Min | 2500 | mg/Kg |
| Total Tocopherols | Min | 45 | mg/100 g |
| Total Tocotrienols | 130 | | mg/100 g |
| Vitamin E TE (Tocopherols Equivalent) | Min | 50 | mg/100 g |

*The analyses are carried out during the packaging.

Object of the invention is also an edible durum wheat oil 100 characterized by a sterol fraction containing stanols (campestanol from 15 to 30% w/w and sitostanol from 15 to 20% w/w) and having more preferably the following chemical and chemical-physical characteristics (Table 4a).

The unsaponifiable fraction is determined by the UNI EN ISO 3596:2002 method.

TABLE 4
Chemical and chemical-physical characteristics

| Characteristic | Value | Analysis method |
|---|---|---|
| Relative density at 20/20° C. | from 0.918 to | UNI EN ISO 6883, ISO 18301 |
| | 0.925 | Determination of the relative |
| | | density (with suitable |
| | | conversion factor) |
| Iodine number | from 125 to140 | UNI EN ISO 3961, [3], [4], |
| | | [5] Determination of the |
| | | iodine number according to |
| | | AOAC 993.20, AOCS Cd 1d |
| | | 1992 (97) and NMKL 39 (2003) |
| Fatty acids composition, | | UNI EN ISO 12966 |
| (capillary) GLC, %: | | |
| Myristic acid | ND | |
| Palmitic acid | from 12.0 to 19.0 | |
| Palmitoleic acid *⁾ | max. 0.3 | |
| Heptadecanoic acid | max. 0.1 | |
| Stearic acid | from 1.0 to 2.0 | |
| Oleic acid *⁾ | from 12.0 to 25.0 | |
| Linoleic acid | from 52.0 to 59.0 | |
| Linolenic acid | from 3.0 to 10.0 | |
| Arachic acid | max. 1.0 | |
| Eicosenoic acid | max. 1.0 | |
| Behenic acid | ND | |
| Lignoceric acid | ND | |
| Sterol composition, | | UNI EN ISO 12228- |
| (capillary) GLC, %: | | Determination of the sterol |
| Cholesterol | max. 0.5 | composition by gas- |
| Brassicasterol | max. 0.2 | chromatography with capillary |
| 24-Methylene cholesterol | max. 1.0 | column according to NGD |
| Campesterol | from 10.0 to 20.0 | C71-C72: 1989 |
| Campestanol | from 15.0 to 30.0 | |
| Stigmasterol | from 1.0 to 3.0 | |
| Delta-7-Campesterol | max 1 | |
| Delta-5,23-Stigmastadienol | <0.1 | |
| Clerosterol | <0.5 | |
| Beta-Sitosterol | 30.0 to 40.0 | |
| Sitostanol | from 15 to 20 | |
| Delta-5-Avenasterol | from 4.0 to 7.0 | |
| Delta-5,24-Stigmastadienol | max 1.5 | |
| Delta-7-Stigmastenol | from 1.5 to 3,5 | |
| Delta-7-Avenasterol | from 2.0 to 4.0 | |
| Sterol content (mg/kg) | from 15 000 to 25 000 | UNI EN ISO 12228-1 |

*⁾ Sum of the positional isomers which can be separated or not in the analysis condition.

Further, the edible durum wheat oil 100 has the hereinbelow characteristics (Table 4b).

| Characteristic | Requirement | Analysis method |
|---|---|---|
| Organoleptic characteristics: | | |
| Smell and taste: | The oil shall not have | |
| | unusual or unpleasant | |
| | smells or tastes. | |
| Aspect: | Clear at 20° C. | |
| Acidity, expressed as oleic | max. 0.5 | UNI EN ISO 660 Acidity |
| acid, % | | determination according to |
| | | AOCS Cd 3d-63 (03) |
| Peroxides number, | max. 7.0 | UNI EN ISO 3960 Peroxides |
| meq O₂/kg | | number determination |
| | | according to AOCS Cd 8b-90 |
| | | (03) |
| Impurity (petroleum ether), % | max. 0.05 | UNI EN ISO 663 Insoluble |
| | | impurities content |
| | | determination |
| Soaps, expressed as sodium | max. 10 | Soap determination according |
| oleate, mg/kg | | to AOCS Cc 17-95 (97) and |
| | | NGD C8 1976 |
| Saponification number | from 180-190 | UNI EN ISO 3657 |
| mgKOH/g | | Unsaponifiable matter |
| | | determination according to |
| | | AOCS Ca 6b-53 (01) |
| Unsaponifiable fraction g/kg | from 20.0 to 40.0 | UNI EN ISO 3596 and UNI EN |
| | | ISO 18609 |
| Moisture and volatile | max 0.2 | UNI EN ISO 662 |
| substances at 105° C. % | | |
| Metals, mg/kg: | | |
| iron | max. 1.5 | UNI EN ISO 8294 - |
| | | Determination of copper, iron |
| | | content according to AOCS Ca |
| | | 18b-91 (03) and AOAC |
| | | 990.05) |
| copper | max. 0.1 | UNI EN ISO 8294 - |
| | | Determination of copper, iron |
| | | content according to [10] |
| | | AOCS Ca 18b-91 (03) |
| | | and AOAC 990.05 |
| lead | max. 0.1 | UNI EN ISO 12193 - |
| | | Determination of lead content. |
| | | Method by graphite furnace |
| | | atomic absorption |
| | | spectrophotometry. |
| arsenic | max. 0.1 | AOAC 986.15-2000 Arsenic, |
| | | Cadmium, Selenium, Zinc |
| | | determination in food and pet |
| | | food |
| Solvents, mg/kg: | | |
| hexane | max. 1 | UNI EN ISO 9832 |
| Permitted additives and | According to current legislation | |
| limits thereof | | |

The refining step 1g can comprise in turn some sub-processes allowing to obtain different products, including:
a step 1g-2 of enzymatic degumming of the durum wheat oil 100 occurring by addition of specific enzymes lecithinases (such as PURIFINE® LM from DSM); during this process step the wheat lecithins are enzymatically separated, naturally contained in the oil at a concentration of 3-5% w/v. After enzymatic treatment a water/lecithins mixture is obtained, which will be subsequently dried. The thus obtained lecithins 200 are widely used ingredients in the food field for their emulsifying properties; they are minor ingredients (<3%) in many formulations of leavened baked goods (pandoro, panettone, croissant, etc.);
a step 1g-3 of durum wheat oil 100 deacidification through which, by adding a sodium hydroxide aqueous solution, a chemical reaction occurs between the free fatty acids (free acidity or FFA) and the sodium hydroxide itself forming the so-called soaps. The free acidity is thus reduced to the minimal values provided for by the law for the seed oils (art. 18 DPR 22/12/54 n. 1217);
a step 1g-4 of discoloration which provides for subjecting the semi-refined wheat oil to a discoloration treatment removing the pigments, such as mainly carotenoids and possible traces of soaps and other undesired substances. The removal of such substances occurs preferably by the physical adsorption process on chemically activated bleaching earths, such as active charcoals. The oil placed in a sealed recipient is contacted with bleaching earths in a proportion of about 4% w/w, at a temperature of 80-90° C. for a time variable according to the oil type. The earths are removed by filtration:
a step 1g-5 of deodorizing representing the last operation of the process of the durum wheat oil refining providing for the oil deodorizing by steam distillation under high vacuum at temperatures comprised between 200 and 260° C. for a time variable between 30-60 minutes. With the deodorizing step all the volatile substances, traces of free fatty acids, intermediates of fatty acids oxidation, unsaturated hydrocarbons, and traces of proteins are removed. Also traces of tocopherols, phytosterols, possible residues of phyto-drugs and possible traces of liposoluble mycotoxins are removed.

Further object of the invention is the durum wheat oil 100 which is further processed and obtained at the end of each step 1g-2, 1g-3, 1g-4, and/or 1g-5.

At the end of the oil extraction process the durum wheat oil 100 is thus obtained together with a defatted meal 300 constituting an intermediate product suitable to be subjected to other splitting processes in order to obtain flour products with protein and fiber high content, as described herein below.

As said, the defatted meal 300 constitutes an intermediate product suitable to be subjected to other splitting processes, including the process 2 for obtaining flour products of defatted durum wheat germ 400 and defatted durum wheat bran 500.

Said defatted durum wheat bran 500 can be advantageously subjected to further micronization 4a and turbo-separation 4b to give the wheat fiber 800.

Said flour products can be obtained, in their commercial and product names, only if deriving from milling fractions without the lipide fraction, therefore defatted.

In order to obtain such flour products of defatted durum wheat germ 400 and defatted durum wheat bran 500, starting from the defatted meal 300 obtained as above, a solvent removal step 2a is advantageously carried out providing for the convection drying with saturated vapor injections at a temperature preferably of about 85° C., preferably for about 1 hour.

Following such solvent removal step 2a, the process 2 for obtaining flour products of defatted durum wheat germ and bran according to the present invention, advantageously provides for, according to a first preferred embodiment of the process, a micronization step 2b and a separation preferably by turbo-separation or air classification 2c.

The technology applications of micronization 2b and turbo-separation (air classification) 2c are known in the food field and all show that the particle size reduction is determinant for the main nutrient (fiber and proteins) separation of the defatted meal.

The process 2 for obtaining flour products of defatted durum wheat germ and bran according to the present invention provides for a first high speed milling step, preferably carried out by a pin mill or pin micronizer, preferably the Contraplex pin mill CW 250 II type (ALPINE-HOSOKAWA). Preferably, with speed rotation comprised between 3,000 and 5,000 rpm.

Said specific micronizer belongs to the impact mill family with two driven pin discs. In counter rotation mode it is possible to obtain higher relative speeds than with any other impact mill operated with only one engine. The relative speeds between the pin discs can reach 240 m/s and they are thus intended to the ultra-fine milling of various different products. The particle size reduction degree is established by the regulation of the speed of the pin discs.

The subsequent air classification step 2c is known in the prior art also as turbo-separation.

According to the process 2 for obtaining flour products of defatted durum wheat germ and bran according to the present invention, said air classification or turbo-separation step 2c is preferably carried out by an air classifier such as the Alpine Turboplex classifier ATP (ALPINE-HOSOKAWA). Advantageously the main air flow rate can be of about 500-1000, preferably 500-800, m³/h and the secondary air flow rate of about 400-800, preferably 400-700 m³/h.

After being entered in the machine, the classification air flows through the classification wheel in a directional centripetal. In the process, the classification wheel extracts the powders from the raw material and conveys them to the discharge; the gross material rejected from the classification wheel gravitates downward. The product is fed through a rotative valve in the upper part of the classifier; the products obtained at the end of the process are two: a fine fraction, with a minor particle size, and a gross fraction, with a major particle size.

According to a second preferred embodiment of the process 2 for obtaining flour products of defatted durum wheat germ and bran according to the present invention, as an alternative of the micronization 2b and turbo-separation (air classification) 2c steps aforementioned, the separation process of the defatted meal 300 can advantageously provide for a tribo-electric separation step 2d (or Dry Tribo-electrostatic Protein Enrichment).

The conventional dry separation processes, such as the air classification and the sieving, are based on differences in the size and/or density of the particles being used as driving force. Nevertheless, the particles with different compositions can be milled to similar size, which limits the maximum level of obtainable purity.

By separating the fiber fragments from the protein, the protein amounts of the product obtained at the end of the fraction is further increased. To obtain such a result, in the second preferred embodiment of the process 2 for obtaining flour products of defatted durum wheat germ and bran according to the present invention, an electrostatic separation of the particles is carried out, particles which are separated based on their different behaviors of tribo-electric charge.

The electrostatic separation of the particles is obtained firstly by charging the particles and then separating them in an external electric field (Haga, 1995); this occurs in this specific case through the passage of the micronized defatted meal 300, i.e., obtained downstream the micronization step 2b, on two opposite and differently electrically charged conveyor belts. The separation occurs by different adhesion of the compounds to the belts.

The flour product of defatted durum wheat germ 400 obtained with the process 2 for obtaining flour products described so far is characterized by a high protein content, higher than 25% w/w, as better shown in Table 5, wherein the average analytical characteristics of the defatted wheat germ flour 400 are reported.

As said, the defatted meal of durum wheat germ and bran 300 constitutes an intermediate product which can be subjected to other splitting processes, including the process 3 for obtaining natural sourdough by biological fermentation.

Starting from the defatted meal 300 as above obtained, a solvent removal step 3a is advantageously carried out providing for the convection drying with saturated vapor injections at atmospheric pressure at a temperature preferably of about 100° C., preferably for about 1 hour.

Subsequently to said solvent removal step 3a, the process 3 for obtaining natural sourdough by biological fermentation of a defatted meal of durum wheat germ and bran 300 according to the present invention, advantageously provides for a biological fermentation step 3b characterized in that it inoculates with a starter of lactic acid bacteria suitable for the nutritional and functional amelioration of the defatted meal of durum wheat germ 300.

More in particular, advantageously said step 3b of biological fermentation provides for realizing a mixture consisting of water (50% w/w) and meal (50% w/w) and for inoculating a starter of lactic acid bacteria, preferably of Lactobacillus plantarum (more preferably the T6-B10 strain) and Fructilactobacillus sanfranciscensis (more preferably the A2S5 strain), at a cellular density in the mixture of 6 log10 UFC/g.

Subsequently to an incubation step, preferably at 25° C. for 16 h, a natural sourdough 600 of type II (not dehydrated) is obtained.

The thus obtained product can be advantageously subjected to a drying step 3c carried out preferably through an oven dehydration at 55° C. for about 16 h, allowing to obtain a natural sourdough 700 of type III (dehydrated).

The obtained dry natural sourdough 700 was used as ingredient in leavened baked goods, leading to great results in terms of organoleptic (smell, taste) characteristics and sapidity amelioration for the significative natural presence of glutamic acid.

From what shown, the process according to the present invention advantageously allows to obtain durum wheat oil 100 and a defatted meal 300, besides to flour products of defatted durum wheat germ 400 and defatted durum wheat bran 500 with peculiar nutritional values and organoleptic characteristics.

A further object of the invention is the use of flour products of defatted durum wheat germ 400 and defatted durum wheat bran 500 obtained according to the invention in the preparation of food products, in particular whole wheat pasta.

The following Examples further illustrate the invention.

### EXAMPLES

### Example 1—Preparation of a durum wheat oil 100 and a defatted meal 300

The durum wheat characterized by WGA>100 ppm and α-tocopherol>30 ppm is wet, advantageously with filtered water, with an electric conductivity value of 5 μS/cm, at pH 7, to an extent of 3% w/w with respect to the durum wheat, and left to rest in silos referred to as “rest cells” for 6 hours.

After the conditioning, the wheat is subjected to the milling step 1b and to the selection of the milling fractions. During the first milling step 1b the pre-cleaning, cleaning, and optical selection operations are carried out, while in the second milling step 1c, referred to as decortication, instead, the largest part of the bran and germ is removed.

At this point, while the internal part of the decorticated caryopsis continues the milling process, the external part of the decortication was directly sent to the oil extraction plant. From the milling process of the decorticated caryopsis, instead, other by-products containing bran and germ derive, commonly referred to as “middlings,” which are also sent directly, in a continuous flow, to the oil extraction process. Then, a mixture was realized consisting of 60% w/w decorticated durum wheat and 40% w/w durum wheat middling. Afterwards, the pelletizing step 1d was carried out, i.e., the milling fractions of durum wheat germ and brans were compressed in a pelletizer at a temperature of 80° C. for 10 minutes.

At the end of this step, wherein the milling fractions are produced by the mills until the final realization of the pellet, the latter was dried (step 1e) on continuous belts at a temperature of 90° C. in HTST (high temperature short time), with the addition of a water/vapor mixture at a temperature preferably of about 90° C., until obtaining a final moisture of 8% w/w.

After the drying step 1e the raw oil extraction step 1f from the dried pellet was started, carried out in a counter-current flow of mixtures enriched of solvent n-hexane at a temperature of 65° C. for 4 hours until obtaining a maximal residue of oil in the meal equal to 0.5% w/w of the total lipides. Raw durum wheat oil was then obtained and a defatted meal of durum wheat germ and brans 300, intermediate product for subsequent processing.

The raw oil, to be made edible, was subjected to a refining process 1g comprising in sequence:
a step 1g-2 of enzymatic degumming of the durum wheat oil 100 by adding PURIFINE® LM from DSM; during this process step the wheat lecithins 200 were enzymatically separated, naturally contained in the oil at a concentration of 3-5% w/v;
a step 1g-3 of deacidification of the durum wheat oil 100;
a step 1g-4 of discoloration wherein the oil, placed in a sealed recipient, is contacted with bleaching earths in a proportion of 4% w/w, at a temperature of 80° C. The earths were removed by filtration;
a step 1g-5 of deodorizing providing for the oil deodorizing by steam distillation under high vacuum at a temperature of 230° C. for 30 minutes.

At the end of the refining step 1g the durum wheat oil 100 is obtained characterized as in the Tables 1, 2, 3 and 4.

### Example 2—Preparation of Flour Products of Defatted Durum Wheat Germ 400 and Defatted Durum Wheat Bran 500

Starting from a defatted meal 300, obtained according to Example 1, a solvent removal step 2a was carried out, convection drying the meal with saturated vapor injections at a temperature of 95° C., at atmospheric pressure for 1 hour. Subsequently, a micronization step 2b was carried out, wherein the defatted meal without solvent was micronized with a pin mill or pin micronizer, at a speed of 3000 rpm. Finally, the defatted meal, without solvent and micronized, was then sorted with an air classifier (step 2c) with a main air flow rate of about 500 m³/h and a secondary air flow rate of about 400 m³/h. At the end of this process (process 2), a defatted durum wheat germ flour 400, characterized by a high protein content, higher than 25% w/w, as better shown in Table 5, and a defatted durum wheat bran 500 characterized by a high level of Total Dietary Fibers (TDF), higher than 45% w/w, and a high content of Arabinoxilanes, higher than 25% w/w were obtained.

### Example 3—Characterization of the Defatted Durum Wheat Germ and Defatted Durum Wheat Bran Flour

The average analytical characteristics of the defatted wheat germ flour 400 obtained according to Example 2 were determined, reported in Table 5.

TABLE 5
Average analytical characteristics of the defatted wheat germ

| | Minimum and | |
|---|---|---|
| Nutrients | maximum values | UM |
| Moisture | 8-12 | % |
| Fats | 0.5-1.0 | % d.m. |
| Carbohydrates | 30-40 | % d.m. |
| Fibers ⁽*⁾ | 20-30 | % d.m. |
| Proteins | 26-30 | % d.m. |

⁽*⁾ = TDF (Total Dietary Fiber) determined according to the AOAC 2017.16 method

In order to demonstrate that the above flour (FF) is defatted durum wheat germ flour 400, laboratory analyses were carried out allowing to quantify the WGA present in a certain number of samples in triplicate of this flour fraction 400 and of the pure durum wheat germ (WG) as a reference sample.

The obtained results are shown hereinbelow (Table 6):

TABLE 6
Results of the laboratory tests on flour (FF)

| | Average WGA content | Standard deviation |
|---|---|---|
| Sample | (μg/g) ppm | (μg/g) ppm |
| FF | 106.50 | 6.89 |
| WG | 102.24 | 1.97 |

FF = High protein content flour (>25%);
WG = Pure durum wheat germ

In order to demonstrate that the above flour (FF) is defatted durum wheat germ, a test on two samples was carried out. The test hypotheses are the following:
H0: There is no statistically significative difference between the WGA average content in FF and the WGA average content in WG;
H1: There is a statistically significative difference between the WGA average content in FF and the WGA average content in WG.

The results of laboratory tests are given in the Table 7.

TABLE 7

| | FF | WG |
|---|---|---|
| Mean | 106.50 | 102.23 |
| Variance | 47.52 | 3.86 |
| Gdl | 10 | |
| Stat t | 1.66395177 | |
| P(T <= t) | 0.063548559 | |

FF = High protein content flour (>25%);
WG = Pure durum wheat germ

Since the p-value is higher than 0.05, it is not possible to refuse the null hypothesis. Therefore, on the basis of the performed tests, it is possible to state that there is a statistically significative difference between the WGA average content in FF and the WGA average content in WG, at a confidence interval of 95%.

It follows that this fraction, FF, is consisting of defatted wheat germ. This hypothesis was confirmed also by other chemical analyses, including the qualitative-quantitative composition of the protein fraction. In particular:
Soluble proteins (Albumins and Globulins): >40% w/w of the total proteins;
“Limiting” amino acid Lysine: >4.5 g/100 g total proteins.

According to what widely reported in the scientific literature in relation to the wheat germ protein qualitative composition.

The flour product of defatted durum wheat bran 500 obtained with the process 2 for obtaining flour products described so far is characterized by a high fiber content (total dietary fiber>50%).

From the bromatological characterization the flour corresponds to the commercial and product definition of the defatted wheat bran.

The average analytical characteristics of the defatted wheat bran are listed below in Table 8.

TABLE 8

| | Minimum and | |
|---|---|---|
| Nutrients | maximum values | UM |
| Moisture | 8-12 | % |
| Fats | 0.5-1.0 | % d.m. |
| Carbohydrates | 20-30 | % d.m. |
| Fibers ⁽*⁾ | 45-55 | % d.m. |
| Proteins | 12-16 | % d.m. |

⁽*⁾ = TDF (Total Dietary Fiber) determined according to the AOAC 2017.16 method

### Example 4—Preparation and Characterization of a Type-2 Sourdough of Durum Wheat Germ and Bran

Starting from the defatted meal 300 obtained according to the Example 1 a solvent removal step 3a was carried out consisting in the convection drying with saturated vapor injections at atmospheric pressure at a temperature of about 95° C. for about 1 hour.

Afterwards, a biological fermentation step 3b was carried out by preparing a mixture consisting of water (50% w/w) and meal (50% w/w) and a starter of lactic acid bacteria of Lactobacillus plantarum T6-B10 and Fructilactobacillus sanfranciscensis A2S5 at a cellular density in the mixture of 6 log10 UFC/g.

Subsequently to an incubation step at 25° C. for 16 h, a natural sourdough 600 of type II (not dehydrated) is obtained.

The thus obtained product was subjected to a drying step 3c by oven dehydration at 55° C. for about 16 h, obtaining a natural sourdough 700 of type III (dehydrated).

In Table 9 hereinbelow the parameters characterizing the product during the process are reported, in particular during the drying step 3c from time to (beginning of the process) to time t₁₆ (end of the process).

TABLE 9
Product parameters during the process

| Not dehydrated (type II) | | | | Dehydrated (type III) | | |
|---|---|---|---|---|---|---|
| | | TTA | LAB | | TTA | LAB |
| | | (ml 0.1N | (Log 10 | | (ml 0.1N | (Log 10 |
| | pH | NaOH) | ufc/g) | pH | NaOH) | ufc/g) |
| t0 | 6.2 | 2.7-3.7 | 6.00 | — | — | — |
| t16 | 4.7 | 15-25 | 9.50 | 4.7 | 50 | 3.51 |

TTA=Titratable Total Acidity; LAB=Lactic Acid Bacteria

As noted, the composition in protein amino acids, after fermentation, had a significative qualitative-quantitative increase, as shown in Table 10 hereinbelow.

The increase is very important from the nutritional point of view.

TABLE 10
Amino acid composition of the meal proteins

| Amino acid composition | Defatted meal (d/m) | Type-2 sourdough (d/m) |
|---|---|---|
| Aspartic acid | 212.891 | 850.48 |
| Threonine | 20.269 | 418.02 |
| Serine | 35.610 | 238.31 |
| Glutammic acid | 243.647 | 507.42 |
| Glycine | 35.926 | 304.60 |
| Alanine | 71.370 | 733.63 |
| Valine | 47.798 | 558.82 |
| Cysteine | 13.576 | 6.05 |
| Methionine | 15.271 | 182.18 |
| Isoleucine | 29.822 | 327.00 |
| Leucine | 82.358 | 462.63 |
| Tyrosine | 32.115 | 170.74 |
| Phenylalanine | 49.899 | 362.57 |
| γ-Aminobutyric acid | 96.665 | 795.94 |
| (GABA) | | |
| Orinithine | 2.047 | 13.94 |
| Lysine | 26.045 | 849.05 |
| Histidine | 7.972 | 206.84 |
| Tryptophan | 96.713 | 570.80 |
| Arginine | 121.285 | 1014.38 |
| Proline | 24.052 | 514.87 |
| Total (mg/Kg) | 1265.331 | 9088.28 |

In the following Table 11 the average composition of the type-2 sourdough obtained from the defatted meal is reported.

TABLE 11
Average nutritional declaration of the type-2
sourdough obtained from the defatted meal

| Nutrients | Average value |
|---|---|
| Energy (kJ) | 1070 |
| Energy (kcal) | 256 |
| Fats % | 0.5 |
| of which saturated % | <0.1 |
| Carbohydrates % | 25 |
| of which sugars % | <0.8 |
| Fibers % ⁽*⁾ | 40 |
| Proteins % | 18 |

⁽*⁾ = TDF (Total Dietary Fiber) determined according to the AOAC 2017.16 method

### Example 5—Characterization of an Oil Extracted from Durum Wheat Germ and Bran

### Methods

Method for the fat extraction from the wheat grain: DM 23-07-1994 SO n. 4 G.U. n. 186 of Oct. 8, 1994

Method for the determination of FFA: UNI EN ISO 660

The influence of the water quality and pH used for the durum wheat conditioning step or wetting, 1a, was evaluated, on the characteristics of the extracted oil.

Two batches of durum wheat oil were analyzed following the conditioning with drinking water and osmotized water (pH comprised between 7 and 9.5) and characterized by an electric conductivity value comprised between 5 and 25 μS/cm, and subsequently each sample was analyzed in triplicate. In Table 12 the results of the free acidity percentage are shown (FAA expressed in % m/m of the present free oleic acid).

TABLE 12

| | Wheat conditioned with | Wheat conditioned with |
|---|---|---|
| | drinking water mix | osmotized water mix |
| | % acidity | % acidity |
| Batch | (% w/w oleic acid) | (% w/w oleic acid) |
| 888 | 9.4 ± 0.2 | 5.5 ± 0.2 |
| 213169 | 8.3 ± 0.2 | 4.9 ± 0.8 |

From Table 12 the significantly lower acidity value found in the wheat conditioned with osmotized water is evident, according to the conditioning step or wetting, 1a, of the process of the invention, with respect to the average of the acidity values in the wheat conditioned with drinking water.

1. A process for obtaining durum wheat oil and a defatted meal starting from durum wheat characterized by a content of WGA>100 ppm and α-tocopherol>8 ppm, wherein said process comprises the following steps:
conditioning, or wetting, 1a of the durum wheat wherein the wheat is wet with filtered or osmotized water and characterized by an electric conductivity value comprised between 5 and 25 μS/cm, and subsequent rest;
first milling 1b and optical selection of the milling fractions;
second milling 1c of decortication;
pelletizing 1d to obtain pellets;
drying 1e of pellets;
extracting 1f of the raw oil; and
refining 1g to obtain the durum wheat oil and a defatted meal.

2. The process according to claim 1, wherein α-tocopherol ranges from 30 to 60 ppm.

3. The process according to claim 1, wherein the conditioning step 1a of the durum wheat provides for the wetting of the wheat with water in an amount variable from 3 to 5% w/w with respect to the durum wheat at a pH comprised between 7 and 9.

4. The process according to claim 1, wherein the subsequent rest occurs for 6-8 hours.

5. The process according to claim 1, wherein the extraction step 1f of the raw oil occurs by a continuous process in a counter-current flow of enriched mixtures of solvent n-hexane/wheat oil.

6. The process according to claim 5, wherein the extraction occurs at a temperature of 65° C. for a period of 4-5 hours until obtaining an oil maximum residue in the meal equal to 0.5% w/w of the total lipids.

7. The process according to claim 1, wherein the refining step 1g comprises a step 1g-2 of enzymatic degumming of the durum wheat oil by adding enzymes lecithinases.

8. The process according to claim 1, wherein the refining step 1g comprises a step 1g-3 of deacidification of the durum wheat oil by adding an aqueous solution of sodium hydroxide.

9. The process according to claim 1, wherein the refining step 1g comprises a step 1g-4 of discoloration of the durum wheat oil.

10. The process according to claim 1, wherein the refining step 1g comprises a step 1g-5 of deodorizing of the durum wheat oil.

11. The process according to claim 1, further comprising the following steps:
removing solvent 2a by meal drying from the defatted meal as obtained from step 1g of the process according to claim 1;
micronizing 2b and separating 2c of the micronized defatted meal; thus obtaining flour products of defatted durum wheat germ and defatted durum wheat bran.

12. The process according to claim 1 further comprising the following steps:
removing solvent 2a by meal drying from the defatted meal as obtained from step 1g of the process according to claim 1;
realizing 2b of a mixture consisting of 50% w/w water and 50% w/w dried meal obtained in the step 2a and inoculating a starter of lactic acid bacteria and subsequent incubating to obtain a non-dehydrated type-2 sourdough;
possible drying 3c to obtain a dehydrated natural sourdough.

13. The process according to claim 12, wherein the starter consists of Lactobacillus plantarum and Fructilactobacillus sanfranciscensis at a cellular density in the mixture of 6 log10 UFC/g.

14. The process according to claim 11, wherein said process further comprises the following steps:
micronizing 4a of the defatted durum wheat bran as obtained from step 2b and 2c of the process according to claim 11, and
air classifiying or turbo-separating 4b carried out by an air classifier; thus obtaining wheat fiber.

15-18. (canceled)

19. Defatted durum wheat germ and defatted durum wheat bran flour products obtained by the process of claim 11.

20. A natural sourdough obtained by the process of claim 12.

21.-26. (canceled)

27. A wheat fiber obtained by the process according to claim 14.
